(19) United States
(12) Patent Application Publication
(10) Pub. No.: US 2008/0170133 A1
(43) Pub. Date: Jul. 17, 2008

(54) Video processing method and system for a virtual camera

(75) Inventors: Kuo Hsiang Sun, Taipei (TW); Wen-Shiu Hsu, Taipei (TW)

Correspondence Address: QUINTERO LAW OFFICE, PC, 2210 MAIN STREET, SUITE 200, SANTA MONICA, CA, 90405, US

(73) Assignee: ASUSTEK COMPUTER INC., TAIPEI CITY (TW)

(21) Appl. No.: 12/013,402

(22) Filed: Jan. 11, 2008

(30) Foreign Application Priority Data
Jan. 17, 2007 (TW) TW96101728

(51) Int. Cl. H04N 5/228

(52) U.S. Cl. 348/222.1; 348/E05.031

(57) ABSTRACT

A video processing system for a virtual camera is disclosed. A processing unit obtains a frame of a video source from a image capture device, determines the maximum frame size of the video stream and a first size and a second size of frames needed by a first application program and a second application program, transfers a first frame whose size conforms to the first size to the first buffer according to the frame size of the video stream, and simultaneously copies and transfers a second frame whose size conforms to the second size from the first buffer to the second buffer. A first virtual camera obtains the first frame from the first buffer and transfers the first frame to the first application program to display. A second virtual camera obtains the second frame from the second buffer and transfers the second frame to the second application program to display.

### BACKGROUND OF THE INVENTION

1. Field of the Invention

The invention relates to a virtual device of a computer system and, more particularly, to a video processing method and system for a virtual camera of the computer system.

2. Description of the Related Art

The basic working principle of a “virtual drive” application program is after generating a virtual optical disk drive by an application program, compressing application programs and information in a optical disk into a virtual optical disk file (*.VCD) which is then stored in a hard disk, and generating a corresponding icon of the virtual optical disk, and then informing the virtual optical disk drive that the compressed file can be viewed as an optical disk in the optical disk drive. When enabling the application program in the optical disk, users do not need to place the original optical disk into the actual optical disk drive (that is, it is executable without an optical disk drive), and to wait for the optical disk drive to start slowly; they just need to click the icon of the virtual optical disk to be played, and then the virtual optical disk is loaded to the virtual optical disk drive and executed. This is very convenient, and problems of replacing an actual optical disk and damaging the actual optical disk can be avoided.

The application program of the virtual optical drive can establish twenty-three virtual optical disk drives which store a lot of CD/DVD optical disks. Multiple disks can be executed simultaneously without replacing disks via different virtual optical disk drives. However, a webcam of a computer system is not applied in a similarly manner, that is, when users execute an application program and use the webcam in the application program, other application programs will be unable to use the webcam.

Therefore, the invention provides a video processing method and system for a virtual camera of the computer system, which enables the webcam to be used by different application programs to make a communication.

### BRIEF SUMMARY OF THE INVENTION

Based on the above objectives, one embodiment of the invention discloses a video processing method for a virtual camera. The method includes the steps of executing a first application program and a second application program and enabling a first virtual camera and a second virtual camera which are corresponding to the application programs, obtaining a frame of a video stream from a video source, and determining the maximum frame size of the video stream and a first size and a second size of frames needed by the first application program and the second application program, respectively, transferring the frame whose size conforms to the first size to a first buffer according to the frame size of the video stream and simultaneously copying and transferring the frame whose size conforms to the second size to a second buffer from the first buffer, obtaining the frame whose size conforms to the first size from the first buffer via the first virtual camera and transferring the frame to the first application program to display, and obtaining the frame whose size conforms to the second size from the second buffer via the second virtual camera and transferring the frames to the second application program to display.

One embodiment of the invention further discloses a video processing system for a virtual camera, and the video processing system includes an image capture device, a first buffer, a second buffer, a first virtual camera, a second virtual camera, a first application program, a second application program, and a processing unit. The image capture device is used for obtaining a video stream. The first buffer and the second buffer are used for storing frames of the video stream temporarily. The first application program and the second application program are used to start the first virtual camera and the second virtual camera, respectively. When the first application program and the second application program are executed and the corresponding first virtual camera and the corresponding second virtual camera are started, the processing unit obtains the frames of a video stream from the image capture device, determines the maximum frame size of the video stream and a first size and a second size of frames needed by the first application program and the second application program, respectively, transfers the frame whose size conforms to the first size to the first buffer according to frame size of the video stream, and simultaneously copies and transfers the frame whose size conforms to the second size from the first buffer to the second buffer The first virtual camera obtains the frame whose size conforms to the first size from the first buffer and transfers the frame to the first application program to display, and the second virtual camera obtains the frame whose size conforms to the second size from the second buffer and transfers the frame to the second application program to display.

### BRIEF DESCRIPTION OF THE DRAWINGS

FIG. 1 is a diagram showing the architecture of the video processing system for a virtual camera according to one embodiment of the invention.

FIG. 2 is a diagram showing steps of the flowchart of the video processing method for a virtual camera according one embodiment of the invention.

FIG. 3 is a diagram showing steps of the flowchart of the video processing method for a virtual camera according another embodiment of the invention.

FIG. 4 illustrates a desktop of an operating system.

### DETAILED DESCRIPTION OF THE EMBODIMENTS

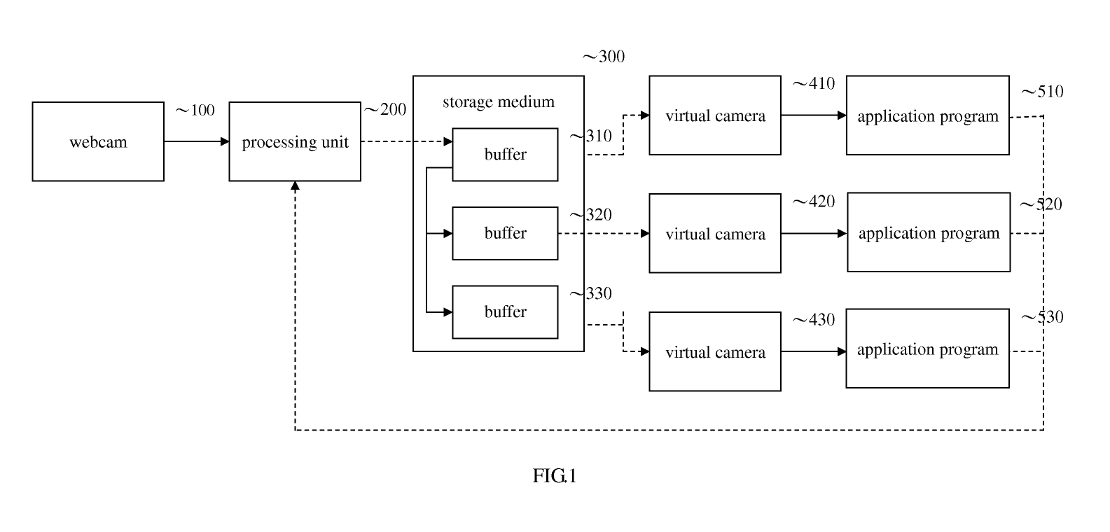

These and other features, aspects, and advantages of the present invention will become better understood with regard to the following description of embodiments coordinated with FIG. 1 to FIG. 3. Disclosure of the invention provides different embodiments to disclose technique features of different implementing manners, wherein the configuration of the elements in the embodiments is just for explanation but not for limitation. Moreover, the repeated reference numbers in the drawings of the embodiments are just for a concise purpose, and do not mean any relevance of different embodiments.

FIG. 1 is a diagram showing the architecture of the video processing system for a virtual camera according to one embodiment of the invention.

The video processing system according to the embodiment of the invention includes a webcam (image capture device) 100, a processing unit 200, a storage medium 300 including multiple buffers 310, 320, and 330, virtual cameras 410, 420, and 430, and multiple application programs 510, 520, 530. Three buffers, three virtual cameras, and three application programs in the embodiment of the invention are just for explanation but not for limitation. In the embodiment, at least two application programs and two virtual cameras are executed to simulate a practical situation. If only one application program is executed, real-time video stream can be obtained from the webcam or by the virtual camera directly.

In the embodiment, the video processing system can be executed in a computer, and the computer can be a desktop computer, a bare bone system, a server, or a portable computer, wherein the portable computer can be a notebook, a tablet personal computer, a palmtop, or an ultra-mobile personal computer (UMPC).

The webcam 100 is, for example, disposed on the display of the video processing system and electrically connected to the processing unit 200. In the embodiment, the processing unit 200 can be a central processing unit (CPU) and is electrically connected to the storage medium 300. In the embodiment, the storage medium 300 can be a volatile memory or a non-volatile memory and can be provided with the multiple buffers 310, 320, and 330.

The virtual cameras 410, 420, and 430 are preferred to be a part of application programs stored in the video processing system.

After executing the application programs 510, 520 and enabling the virtual cameras 410, 420, respectively, the processing unit 200 obtains the frames of the video stream by using the webcam 100. Then the processing unit 200 determines the maximum frame size (resolution) of the video stream and the first size (first resolution) and the second size (second resolution) of frames needed by the application programs 510, 520, respectively. For example, the application programs 510, 520 display a 640×480 (first size) frame and a 320×240 (second size) frame, respectively, wherein the first size (640×480) of the frame is equal to the maximum frame size of the video stream obtained from the webcam 100. The processing unit 200 transfers the frame whose size conforms to the first size (which is equal to the maximum frame size of the video stream) to the buffer 310 according to the frame size of the video stream, and then copies and transfers the frame whose size conforms to the second size (smaller than the first size) from the buffer 310 to the buffer 320.

Next, the virtual camera 410 obtains the frame whose size conforms to the first size from the buffer 310 and transfers the frame to the application program 510 to display. The virtual camera 420 obtains the frame whose size conforms to the second size from the buffer 320 and transfers the frame to the application program 520 to display. If the application program 530 is executed and the virtual camera 430 is enabled, the processing unit 200 determines the size of frame needed by the application program 530 (For example, the frame whose size conforms to the third size and is not the same as the frames with the first or second size), and copies and transfers the frame whose size conforms to the third size to the buffer 330. Then, the virtual camera 430 obtains the frame whose size conforms to the third size from the buffer 330 and transfers the frame to the application program 530 to display.

If the size of the frame needed by the application program 530 is equal to the first size of the frame, the virtual camera 430 obtains the frame with the first size from the buffer 310 and transfers the frame to the application program 530 to display. If the size of the frame needed by the application program 530 is equal to the second size of the frame, the virtual camera 430 obtains the frame with the second size from the buffer 320 and transfers the frame to the application program 530 to display.

Please refer to FIG. 4 showing a desktop of an operating system. The desktop includes three display windows 600, 601 and 602 of the three started application programs and frame size (resolution) of every display window is different from one another

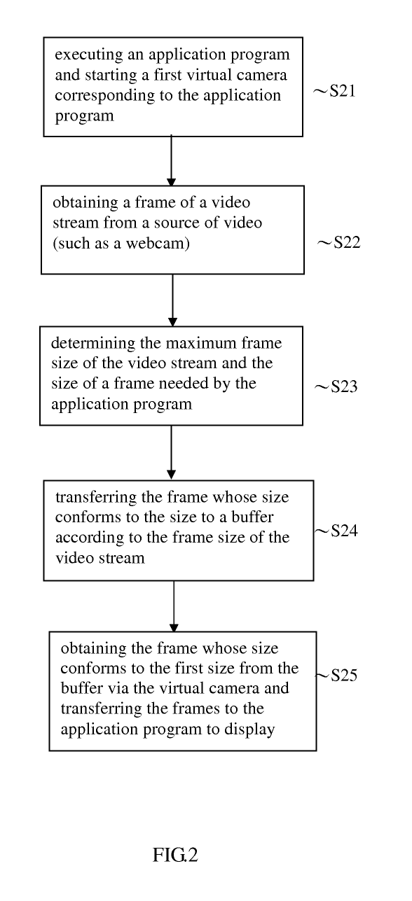

FIG. 2 is a diagram showing steps of the flowchart of the video processing method for a virtual camera according to one embodiment of the invention.

The method includes the steps of first, executing an application program and enabling a virtual camera corresponding to the application program (step S21), obtaining a frame of a video stream from a video source obtained by a webcam (step S22), determining the maximum frame size (resolution) of the video stream and the size of a frame needed by the application program (step S23), and then transferring the frame whose size conforms to the size needed by the application program to a buffer according to frame size of the video stream (step S24), wherein the frame size needed by the application program is equal to the maximum frame size of the video stream, obtaining the frame whose size conforms to the first size from the buffer via the virtual camera, and transferring the frames to the application program to display (step S25).

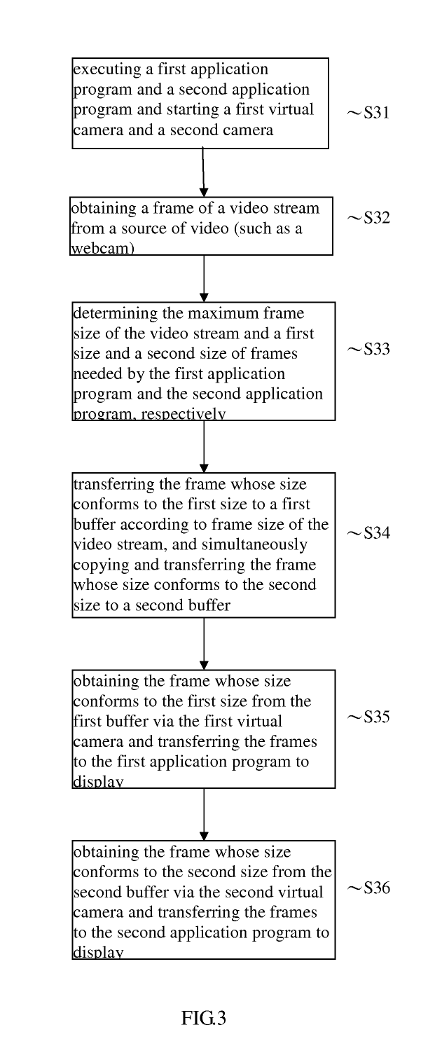

FIG. 3 is a diagram showing steps of the flowchart of the video processing method for a virtual camera according to another embodiment of the invention.

The method includes the steps of first, executing a first application program and a second application program and enabling a corresponding first virtual camera and a corresponding second virtual camera (step S31), obtaining a frame of a video stream from a video source obtained by a webcam (step S32), determining the maximum frame size (resolution) of the video stream and a first size and a second size of frames needed by the first application program and the second application program, respectively (step S33), then, transferring the frame whose size conforms to the first size to a first buffer according to frame size of the video stream and simultaneously copying and transferring the frame whose size conforms to the second size to a second buffer from the first buffer (step S34), wherein, the first size of the frames is equal to the maximum frame size of the video stream.

The method also includes the steps of obtaining the frame whose size conforms to the first size from the first buffer via the first virtual camera and transferring the frame to the first application program to display (step S35), obtaining the frame whose size conforms to the second size from the second buffer via the second virtual camera and transferring the frames to the second application program to display (step S36), if the size of the frame needed by the second application program is equal to the first size, obtaining the frame whose size conform to the first size from the first buffer via the second virtual camera and transferring the frame to the second application program to display.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A video processing method for a virtual camera comprising the steps of:
obtaining a frame of a video stream from a video source;
determining the maximum frame size of the video stream and the size of a frame needed by an application program;
transferring a frame whose size conforms to the size of the frame needed by the application program to a buffer according to the frame size of the video stream; and
obtaining the frame whose size conforms to the size of the frame needed by the application program from the buffer via a virtual camera and transferring the frame to the application program to display.

2. The video processing method according to claim 1, further comprising the steps of executing the application program and enabling the virtual camera corresponding to the application program to display the frame whose size conforms to the size of the frame needed by the application program.

3. The video processing method according to claim 1, wherein the size of the frame needed by the application program is equal to the maximum frame size of the video stream.

4. The video processing method according to claim 1, wherein the video source is obtained by a webcam.

5. A video processing method for a virtual camera comprising the steps of:
executing a first application program and a second application program and enabling a first virtual camera and a second virtual camera;
obtaining a frame of a video stream from a video source;
determining the maximum frame size of the video stream and a first size and a second size of frames needed by the first application program and the second application program, respectively;
transferring the frame whose size conforms to the first size to a first buffer according to the frame size of the video stream, and copying and transferring the frame whose size conforms to the second size to a second buffer from the first buffer; and
obtaining the frame whose size conforms to the first size from the first buffer via the first virtual camera and transferring the frames to the first application program to display; and
obtaining the frame whose size conforms to the second size from the second buffer via the second virtual camera and transferring the frame to the second application program to display.

6. The video processing method according to claim 5, further comprising the steps of obtaining the frame whose size conforms to the first size from the first buffer via the second virtual camera and transferring the frame to the second application program to display if the size of the frame needed by the second application program is equal to the first size.

7. The video processing method according to claim 5, wherein the first size of the frame is equal to the maximum frame size of the video stream.

8. The video processing method according to claim 5, wherein the video source is obtained by a webcam.

9. A video processing system for a virtual camera comprising:
an image capture device for obtaining a video stream;
a first buffer and a second buffer for storing frames of the video stream temporarily;
a first virtual camera and a second virtual camera coupled to the first buffer and the second buffer, respectively;
a first application program and a second application program which are coupled to the first virtual camera and the second virtual camera, respectively, and can enable the first virtual camera and the second virtual camera; and
a processing unit coupled to the image capture device, the first buffer, the second buffer, the first application program and the second application program, respectively, wherein when the first application program and the second application program are executed and the corresponding first virtual camera and the corresponding second virtual camera are enabled, the processing unit obtains a frame of a video stream from the image capture device, determines the maximum frame size of the video stream and a first size and a second size of frames needed by the first application program and the second application program, respectively, transfers the frame conforms to the first size to the first buffer according to the frame size of the video stream, and copies and transfers the frame whose size conforms to the second size from the first buffer to the second buffer;
wherein the first virtual camera obtains the frame whose size conforms to the first size from the first buffer and transfers the frame to the first application program to display, and the second virtual camera obtains the frame whose size conforms to the second size from the second buffer and transfers the frame to the second application program to display.

10. The video processing system according to claim 9, wherein if the size of the frame needed by the second application program is equal to the first size, the second virtual camera obtains the frame whose size conforms to the first size from the first buffer and transfers the frame to the second application program to display.

11. The video processing system according to claim 9, wherein the first size of the frame is equal to the maximum frame size of the video stream.

12. The video processing system according to claim 9, wherein the image capture device is a webcam.
